(19) United States
(12) Patent Application Publication
(10) Pub. No.: US 2006/0152363 A1
(43) Pub. Date: Jul. 13, 2006

(54) System and method for detecting and removing or disabling RFID tags

(76) Inventor: Clifford Kraft, Naperville, IL (US)

Correspondence Address: Clifford Kraft, 320 Robin Hill Dr., Naperville, IL, 60540, US

(21) Appl. No.: 11/020,695

(22) Filed: Dec. 23, 2004

(51) Int. Cl. G08B 13/14

(52) U.S. Cl. 340/568.1

(57) ABSTRACT

A system and method for detecting the presence of and/or removing or disabling RFID tags in commercial items. In one embodiment, the commercial item is subjected to an electromagnetic or particle field of sufficient energy to destroy any embedded RFID tags. In another embodiment, RFID tags are interrogated and located by a local receiver where they then can be removed or destroyed. In still another embodiment, a commercial item is scanned by x-ray similar to existing security systems. Embedded RFID tags are located either manually or automatically and then either removed or destroyed. The detection and removal of RFID tags is also a business method where a fee can be charged for clearing an item of hidden or embedded RFID, tags.

### BACKGROUND

1. Field of the Invention

The present invention relates generally to the field of providing privacy and more particularly to a method and apparatus for detecting and removing or disabling RFID tags.

2. Description of the Prior Art

Radio frequency Identification (RFID) tags are starting to be used by manufacturers to identify warehouse items such as cartons and pallets. Such RFID tags are also starting to appear on individual products found in stores such as bags of coffee, boxed foods, etc. Such RFID tags are radio frequency transponders that respond with identification information when interrogated. U.S. Pat. No. 6,407,669 by Brown et al. shows how an RFID tag can be constructed. U.S. Pat. No. 6,407,669 is hereby incorporated by reference.

It is only a matter of time when RFID tags will be attached or contained in almost every purchased good. They will be used by stores for shelf inventory management, check-out and product tracking. RFID tags may also be used to track consumer buying profiles. For example, it has been proposed that all garments should possibly contain RFID tags. While these tags may only be used for product tracking in stores, it is feared that they may be a major privacy threat since they can identify the type of goods, the source, the price and any other information the merchant wishes to place in the tag.

While some privacy fears may be exaggerated, privacy experts agree that RFID tags do represent a possible threat to personal privacy.

Some RFID tags can be disabled or turned off when the consumer leaves the store—some cannot. The consumer has no way of knowing whether the item just purchased contains RFID tags or not, and whether they have been turned off or not.

What is advantageous would be an apparatus and method for detecting hidden RFID tags in or on garments or any other item, and for permanently removing or turning off these tags so that a consumer can be sure there is no possibility of privacy invasion.

### SUMMARY OF THE INVENTION

The present invention relates to a system and method for detecting and removing or disabling RFID tags in or on items. RFID tags can be destroyed by directed steady or pulsed electromagnetic fields (or particle beams); RFID tags can be located by interrogation using a local receiver. They can then be removed or destroyed; RFID tags can be located by x-ray scan of a commercial item followed by subsequent manual or automatic location of each tag and removal or destruction.

The location and removal/destruction of RFID tags from consumer items is a business method where a fee can be charged for the “cleaning” of purchased goods of hidden or embedded RFID tags.

### DESCRIPTION OF THE FIGURES

FIG. 1 shows an embodiment of the present invention that uses an electromagnetic generator coupled through a suitable antenna to direct electromagnetic energy into a commercial product.

FIG. 2 shows a schematic diagram of a pulsed version of the embodiment shown in FIG. 1.

FIG. 3 shows an embodiment of the present invention that interrogates for the presence of RFID tags.

FIG. 4 shows an embodiment of the present invention that uses x-ray scanning to locate RFID tags in a commercial product.

Several illustrations have been presented to aid in the understanding of the present invention. The scope of the present invention is not limited to the figures.

### DESCRIPTION OF THE INVENTION

The present invention relates to a system and method for removing the privacy threat from RFID tags in garments and any other commercial item. A first embodiment of the present invention passes the commercial item through a high energy electromagnetic field that can be a microwave beam, an electromagnetic pulse (EMP), or any other high energy beam to simply destroy the RFID tag in the commercial item. This technique works for that type of commercial item that does not itself contain any semiconductor electronic parts.

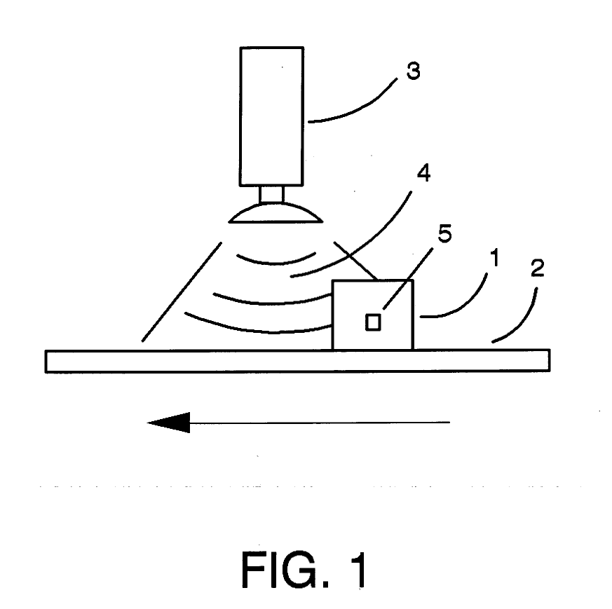

FIG. 1 shows a setup where the commercial item or garment 1 is passed under an antenna fed electromagnetic energy 4 by an electromagnetic generator 3. The item can be fed along a conveyor belt 2, or by any other means. The amplitude of the electromagnetic energy can be fixed or variable, and the energy can be simply a carrier, a pulse, or a modulated carrier. The conveyer 2 can move the item through the field 4 exposing it long enough to destroy any RFID tag 5 in the item.

Several examples of electromagnetic energy that can be used for this purpose are now presented. The scope of the present invention is not limited to these examples:

### EXAMPLE 1

A high-powered microwave carrier operating in the ISM band around 2 GHZ that simply heats the RFID tag to a temperature where it is destroyed.

### EXAMPLE 2

An AM modulated carrier (or an unmodulated carrier) operating in the UHF or microwave band with field strengths in excess of 50-100 volts/meter. The frequency can fixed or varied in an attempt to create resonances in the RFID tag.

### EXAMPLE 3

An x-ray beam that heats the RFID tag to destruction.

### EXAMPLE 4

A fast electromagnetic pulse (EMP) that has a peak field over 1000 volts/meter. Such a pulse can have a risetime of from 500 ps to 10 ns. A 1 ns risetime is preferred resulting in an EMP with a wide frequency distribution.

### EXAMPLE 5

A scanning laser that heats the RFID tag to destruction.

The entire setup in FIG. 1 generally must be shielded to prevent unwanted interference (and possible damage or health consequences) to nearby electronic devices or operators. In particular, it is preferred that the entire assembly meet Class A or Class B standards from FCC Part 15.

While the assembly in FIG. 1 can use x-rays, this leads to shielding difficulties. In particular, it is necessary to use fairly thick lead shielding with x-rays of sufficient energy to destroy semiconductor devices like RFID tags.

Even though it is preferred to use electromagnetic energy in the setup of FIG. 1, any destructive energy beam or source can be used. Particular examples can be a neutron beam, gamma rays, electron beams and any other type of energy beam.

The setup shown in FIG. 1 generally should not cause destruction or heating of the commercial item trying to be cleaned of RFID tags. Electromagnetic energy (such as a microwave beam) is particularly effective on garments that do not contain metal since the fabric is hardly affected by the beam, but items such as an RFID tag immediately heat. The same is true for fixed or pulsed electromagnetic energy.

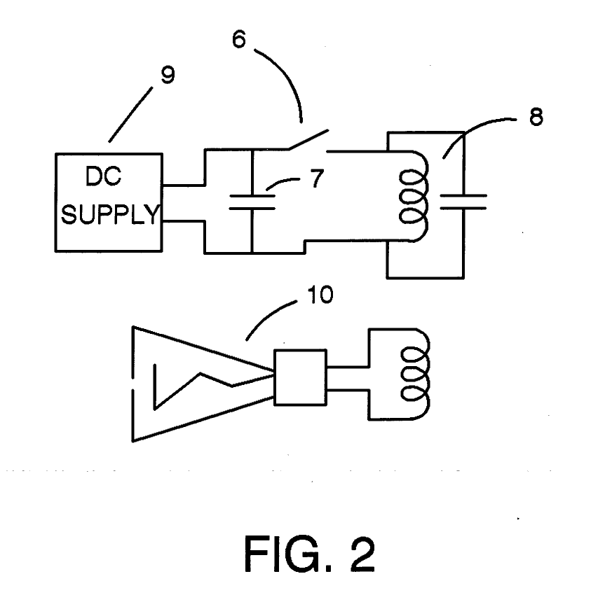

FIG. 2 shows a schematic of a pulsed electromagnetic generator (EMP generator) that can cause very high field strengths with a wide frequency distribution. These fields are very effective at destroying semiconductor chips since any resonance is found by some frequency band. Any energy desired can be generated simply by increasing the capacitor discharge voltage. Bandwidth can be controlled by changing risetime (or falltime). Typical EMP generators use an oscillating waveform with a Gaussian envelope (or a pulse with an exponential risetime followed by a long decay). The limiting factor in this type of generator is usually the high voltage firing contact (switch) 6 that dumps energy out of the capacitor 7 into the tank circuit 8.

The high voltage capacitor in the circuit of FIG. 2 is normally charged to a particular DC target voltage by a DC power supply 9. Energy is stored between the capacitor plates in the form of an electrostatic field. When the dump firing contact 6 is closed, the capacitor 7 dumps current into the tank circuit 8 which tends to oscillate at a particular frequency. The tank circuit 8 couples its energy out to an antenna 10 that radiates it. The power envelope tends to have a Gaussian shape. The tank frequency should be chosen between 20-200 MHz. The resulting signal will have powerful harmonics up into the microwave band. A power clipping diode in the tank circuit can be optionally used to enrich the harmonic spectrum by creating a clipped non-linearity in the carrier. U.S. Pat. No. 5,293,527 by Sutton et al. teaches a pulsed electromagnetic technique. U.S. Pat. No. 5,293,527 is hereby incorporated by reference.

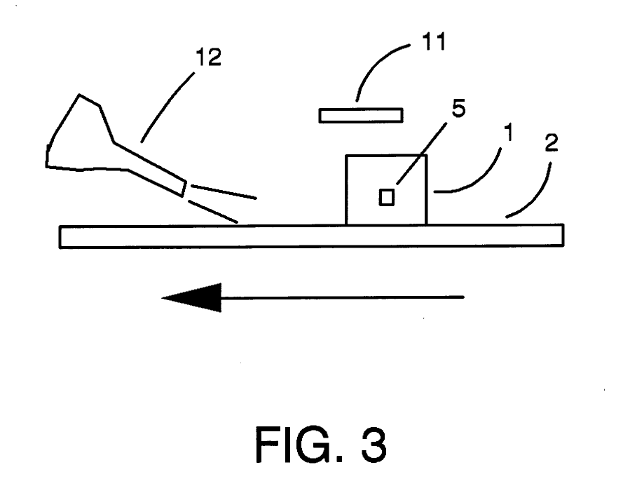

A completely different approach should generally be used when the commercial product itself contains electronic circuits (especially semiconductor chips). An example might be a telephone or a television set. Here, rather than brute-force destruction of the RFID tags, they should be found and either removed or locally destroyed (destroyed by applying energy to them at very close range or by contact). There are at least two ways this can be accomplished. The first is to interrogate the RFID tags and use a receiver to pick up their responses. The problem with this is that there is no universal RFID tag. Also, as new types of tags are developed, interrogation methods and codes may change. Still, the design and coding of RFID tags will generally be available information, and such a system can be effective. FIG. 3 shows an interrogation RFID locator. A garment or object 1 passes through the interrogation beam 11 and each RFID 5 response is noted by the system. A total count of tags in the product can be made, and then a search can be conducted (possibly using a wand type 12 or other very low powered local interrogator) to find each RFID tag 5 one by one. As each is found, it can either be destroyed individually by heating or by conduction of an electric current through it, or it can be removed. A local, focused electromagnetic field or laser beam can be used on a particular tag to destroy it without hurting other nearby electronics.

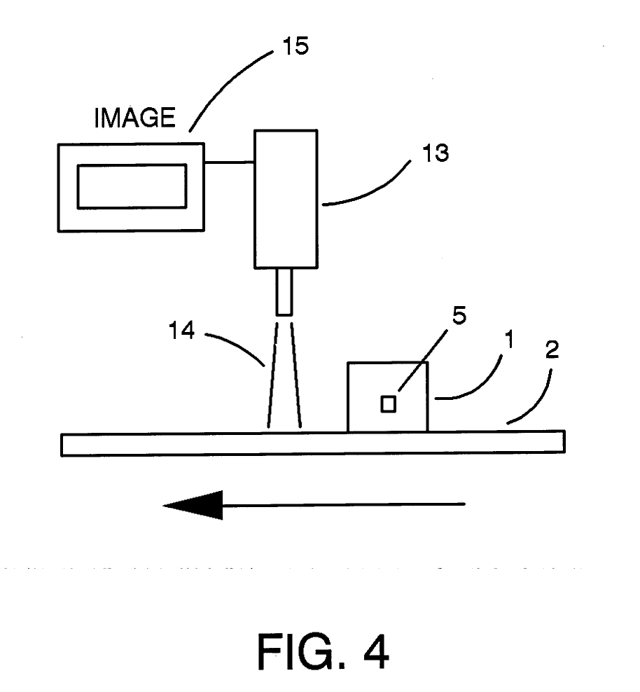

A second method could be to x-ray the commercial object, not with the goal of destroying the RFID tags, but rather with the goal of locating them by pattern recognition. FIG. 4 shows an embodiment of this method. Most RFID tags contain coiled etched antennas that allow them to be recognized. A soft x-ray generator 13 can image the inside of an object 1 without destroying electronics inside by using a narrow beam 14. While such recognition might be done automatically, it is more likely that it will be done by a human manually looking at an x-ray display 15. For this type of inspection, an x-ray machine similar to those used in airport security setups can be used.

After a tag is located in the visual x-ray display 15, it can be marked and actual physical coordinates of the tag can be derived or generated so that the physical RFID tag can be located and either removed or destroyed locally.

The present invention also describes a business method where a customer presents a newly purchased commercial object or garment for RFID tag removal. For a nominal cost, one of the methods described can be used to make the commercial object or garment “safe” from an RFID tag privacy point of view (by disabling or removing all the RFID tags). This process could take only minutes (or even tens of seconds), so the price for such “cleaning” could be low. Since the business model is totally service oriented, the profit is based solely on the throughput (how many objects, garments or items can be “cleaned” per minute, etc.). Costs are mostly startup for equipment. Continuing costs are equipment maintenance and salaries. By running such a business method in an assembly line fashion, prices could be kept low with a reasonable profit margin.

Various illustrations and descriptions have been presented to aid in understanding the present invention. One of skill in the art will realize that many variations and changes are possible. All such variations and changes are within the scope of the present invention, especially in methods used to detect or destroy RFID tags.

I claim:

1. A system for disabling RFID tags in a commercial item comprising:
an electromagnetic field generater generating an electromagnetic field of sufficient energy to destroy an RFID tag;
a carrier for holding a commercial item in said electromagnetic field for a time sufficient to destroy said RFID tag.

2. The system for disabling RFID tags of claim 1 wherein said electromagnetic field is pulsed.

3. The system for disabling RFID tags of claim 1 wherein said electromagnetic field exceeds 100 volts/meter.

4. The system for disabling RFID tags of claim 1 wherein said electromagnetic field contains a microwave frequency component.

5. The system for disabling RFID tags of claim 1 wherein said electromagnetic field is light.

6. The system for disabling RFID tags of claim 1 further comprising a directional antenna for directing said electromagnetic field into said commercial item.

7. A method for removing RFID tags from a commercial item comprising the steps of:
passing said commercial item through an radio frequency interrogator causing an interrogation;
detecting an RFID tag response to said interrogation;
finding a specific location of a particular RFID tag in said commercial item from said RFID tag response;
removing or destroying said particular RFID tag.

8. The method of claim 7 wherein said the step of finding a specific location of a particular RFID tag is accomplished with a wand.

9. The method of claim 7 wherein said particular RFID tag is destroyed by a local electromagnetic field.

10. The method of claim 9 wherein said local electromagnetic field is pulsed.

11. The method of claim 7 wherein said particular RFID tag is located using a directional antenna.

12. A method for locating and removing RFID tags from a commercial item comprising the steps of:
subjecting said commercial item to an x-ray beam, said x-ray beam forming a visual image;
locating an RFID tag in said visual image and noting it as a located RFID tag;
determining a physical location of said located RFID tag in said commercial item;
removing or destroying said located RFID tag.

13. The method of claim 12 wherein said visual image is displayed on a monitor.

14. The method of claim 12 wherein said visual image is analyzed automatically.

15. The method of claim 12 wherein said located RFID tag is destroyed by an electromagnetic field.

16. The method of 15 wherein said electromagnetic field is x-ray.

17. The method of claim 15 wherein said electromagnetic field is pulsed.

18. The method of claim 15 wherein said electromagnetic field is a microwave beam.
